(19) United States
(12) Patent Application Publication
(10) Pub. No.: US 2024/0015860 A1
(43) Pub. Date: Jan. 11, 2024

(54) LATCH AND COOKING APPARATUS INCLUDING THE SAME

(71) Applicant: SAMSUNG ELECTRONICS CO., LTD., Suwon-si (KR)

(72) Inventors: Jiho JEONG, Suwon-si (KR); Sangwon YUN, Suwon-si (KR); Sangjun PARK, Suwon-si (KR); Sangjin JEONG, Suwon-si (KR)

(21) Appl. No.: 18/474,598

(22) Filed: Sep. 26, 2023

Related U.S. Application Data
(63) Continuation of application No. PCT/KR2022/004033, filed on Mar. 23, 2022.

(30) Foreign Application Priority Data
Mar. 31, 2021 (KR) 10-2021-0042355
Jun. 15, 2021 (KR) 10-2021-0077455
Jun. 24, 2021 (KR) 10-2021-0082626
Jul. 22, 2021 (KR) 10-2021-0096203

(51) Int. Cl. H05B 6/64

(52) U.S. Cl. CPC H05B 6/6417

(57) ABSTRACT

A cooking apparatus includes an outer housing including a front panel and a back panel opposite to each other, the front panel including a back surface facing the back panel, an inner housing which is within the outer housing and in which a cooking room of the cooking apparatus is defined, a door which is rotatably coupled to the outer housing at the front panel of the outer housing, and opens and closes the cooking room, and a latch which is coupled to the outer housing at the back surface of the front panel and detects opening and closing of the door.

### CROSS-REFERENCE TO RELATED APPLICATIONS

This application is a continuation application of International Application No. PCT/KR2022/004033, designating the United States, filed on Mar. 23, 2022, at the Korean Intellectual Property Receiving Office and claiming priority to Korean Patent Application No. 10-2021-0042355, filed on Mar. 31, 2021, Korean Patent Application No. 10-2021-0077455, filed on Jun. 15, 2021, Korean Patent Application No. 10-2021-0082626, filed on Jun. 24, 2021 and Korean Patent Application No. 10-2021-0096203, filed on Jul. 22, 2021, at the Korean Intellectual Property Office, the disclosures of which are incorporated by reference herein in their entireties.

### BACKGROUND

### (1) Field

The present disclosure relates to a latch and a cooking apparatus including the same, and more particularly to a latch couplable to a housing and a cooking apparatus including the same.

### (2) Description of the Related Art

In general, a cooking apparatus is a device for heating and/or cooking an object (e.g., a cooking object), such as food. Specifically, the cooking apparatus can perform various functions related to cooking, such as heating, defrosting, drying, and sterilizing the cooking object. Such cooking apparatus includes, for example, an oven, such as a gas oven or an electric oven, a microwave heating device (hereinafter referred to as a microwave), a gas range, an electric range, a gas grill, or an electric grill.

In general, an oven is a device that cooks food by transferring heat directly to the food through a heating source that generates heat such as a heater or by heating the inside of the cooking room. A microwave oven is a device that cooks food by intermolecular friction heat generated by disturbing the molecular arrangement of food using high frequency as a heating source.

A cooking apparatus typically includes a door. The door serves to open and close a cooking space or a cooking room from outside the cooking apparatus. Once the door is closed, it is secured by a latch. The latch includes a switch that senses the opening and closing of the door.

### SUMMARY

The door of the cooking apparatus is rotated to operate the switch that senses the opening and closing of the door. Since the operation of the switch by the door can be defective due to deviations in assembly and dimensional deviations between parts, such deviations are an important factor in product defects.

In particular, in the case of a cooking apparatus that uses a magnetron, it is important that the high frequency generated by the cooking apparatus is controlled so that no high frequency is generated when the door is opened, as the high frequency generated by the cooking apparatus is harmful to living bodies such as the human body. To solve this problem, accurately detecting the opening of the door is desired.

One aspect of the present disclosure provides a latch that is coupled to a back surface of a front panel of an outer housing to accurately detect opening of the door.

Another aspect of the present disclosure provides a cover member that prevents a coupling member, which protrudes from an outer surface of an outer housing from being visible when a latch is coupled to a back surface of a front panel of the outer housing.

Another aspect of the present disclosure provides a latch in which a side of a latch housing facing a front panel of an outer housing is concave, allowing the latch housing to accurately engage the front panel.

According to an aspect of the present disclosure, a cooking apparatus may include an outer housing cover including an upper panel and two side panels, an outer housing including a front panel, a back panel, and a bottom panel, an inner housing positioned on an inner side of the outer housing and having a cooking room formed therein, a door rotatably coupled to a front side of the outer housing for opening and closing the cooking room, and a latch coupled by a cover member to a back side of the front panel of the outer housing for securing the door and detecting opening and closing of the door.

A door further including a manipulation portion coupled to a front side of the front panel to conceal a front portion of the front panel, the latch being coupled to a back side of the front panel by the cover member in a position corresponding to the manipulation portion, such that when the cover member opens the door, it is not visible from the outside.

The latch may include a latch housing including an exterior of the latch, a detecting portion coupled to the interior of the latch housing and detecting the opening or closing of the door, the latch housing being concave in a direction away from the front panel such that both ends of the front panel facing side of the latch housing are in contact with the front panel.

The latch recess may include two planes forming a predetermined angle.

The latch housing may be arranged such that the cover member is coupled to an upper and lower side of the latch housing, respectively, and the latch housing is further from the front panel than two planes such that a space between the parts to which the cover member is coupled forms a predetermined angle of the latch recess.

A step may be formed between the two planes forming the predetermined angle in a shape corresponding to the front panel.

A front panel-facing side of the latch housing may include a latch protruding portion projecting toward the front panel, and a side formed by joining ends of the latch protruding portion may form a recessed latch recess.

The door includes a key door which, when the door is closed, protrudes in a direction toward the latch housing and is detected by the detecting member, the latch housing including a key door opening in which the key door can be received, a coupling opening in which the cover member can be received, and the latch protruding portion can be formed around the key door opening, or can be formed around the coupling opening.

Of the two planes forming the latch recess, one plane may be formed in a position corresponding to the key door opening, and the other plane may be formed in a position corresponding to the coupling opening.

The front panel includes a cooking room opening arranged in a position corresponding to the cooking room, a manipulation portion opening arranged in a position corresponding to the manipulation portion, and an opening connecting portion arranged between the cooking room opening and the manipulation portion opening, where the latch may be coupled to a back surface of the opening connecting portion.

The front panel may include, on one side of the opening connecting portion, a latch guide bent and formed from a front side of the front panel, the latch housing may include a latch protrusion projecting toward the latch guide, and the latch guide may include a latch protrusion accommodating hole arranged to receive the latch protrusion, at a location corresponding to the latch protrusion.

The door may further include a cover member coupled to a front surface of the outer housing, to enclose the door side when the door is closed.

The cover member may include a fastening groove through the latch and the outer housing into which the cover member is engaged to couple the latch to the outer housing.

The cover member may be secured to the latch and the front panel through the cover member, and the cover member may be concealed by the latch and not exposed to the outside.

The cover member includes a cover member opening, and when the door is closed, at least a portion of the door side can be received in the opening of the cover member.

According to another aspect of the present disclosure, a latch may include a latch housing forming an outer surface, a detecting portion coupled to an interior of the latch housing, and a latch recess formed on one side of the latch housing such that, when the latch is coupled to another object, both ends of a side of the latch housing to be coupled to the other object abut a side of the other object to be coupled.

The latch recess may include two planes forming a predetermined angle.

The latch housing may include a latch protruding portion projecting outwardly and a face formed by joining the ends of the latch protruding portion, the latch recess being concave.

According to another aspect of the present disclosure, a cooking apparatus includes an outer housing cover including an upper panel and two side panels, an outer housing including a front panel, a back panel and a bottom panel, an inner housing located on an inner side of the outer housing, in which a cooking room is formed, a door rotatably coupled to a front side of the outer housing for opening and closing the cooking room, a latch engaged by a cover member on a back side of the front panel of the outer housing to secure the door and detect opening and closing of the door, and a cover member engaged on a front side of the outer housing to enclose a side of the door when the door is closed, the cover member being secured to the latch and to the front panel through the latch and to the cover member, the cover member may be concealed by the cover member and not exposed to the outside.

The cover member includes a cover member opening, where at least a portion of the door side can be received in the cover member opening when the door is closed.

According to one aspect of the present disclosure, a latch of a cooking apparatus can accurately detect an open state of a door.

According to another aspect of the present disclosure, a cover member of a cooking apparatus may prevent the cover member from projecting onto an outer surface of the outer housing.

According to another aspect of the present disclosure, the latch housing recessed first side allows the latch to accurately engage the front panel.

### BRIEF DESCRIPTION OF THE DRAWINGS

FIG. 1 is a perspective view illustrating an exterior view of a cooking apparatus according to one embodiment of the present disclosure.

FIG. 2 is a perspective view illustrating a portion of the configuration inside the cooking apparatus shown in FIG. 1.

FIG. 3 is a cross-sectional view of FIG. 1 cut from the inside of the door along a plane parallel to the front panel.

FIG. 4 is an exploded view of the cooking apparatus shown in FIG. 1.

FIG. 5 is a rear perspective view with the outer housing of the cooking apparatus of FIG. 1 removed.

FIG. 6 is an enlarged perspective view of a latch of the cooking apparatus of the present disclosure.

FIG. 7 is an exploded view of the latch and cover member from the enlarged perspective of FIG. 6.

FIG. 8A is a cutaway cross-sectional view of the latch of the cooking apparatus of FIG. 5, and FIG. 8B is an enlarged view of the indicated portion of FIG. 8A.

FIG. 9 is a cross-sectional view of the latch of the cooking apparatus of FIG. 5 cut in a different plane.

FIG. 10 is a side view of a latch of the cooking apparatus when the door is open.

FIG. 11 is a side view of the latch of the cooking apparatus when the door is closed.

FIG. 12 is an exploded perspective view illustrating a door, a cover member, and a front panel of a cooking apparatus.

FIG. 13 is a side view illustrating a combination of the door, cover member, and front panel of the cooking apparatus of FIG. 12.

FIG. 14 is a front view of the cooking apparatus, excluding the door.

FIG. 15 is a perspective view illustrating an exterior view of a cooking apparatus according to another embodiment of the present disclosure.

FIG. 16 is a perspective view of the cooking apparatus disclosed in FIG. 15 with the door open.

FIG. 17 is a rear perspective view of the cooking apparatus of FIG. 15, with the outer housing upper panel and two side panels and the inner housing upper panel removed.

FIG. 18A is a rear perspective view illustrating a door, manipulation portion, front panel, and latch of the cooking apparatus of FIG. 15, and FIG. 18B is an enlarged view of the indicated portion of FIG. 18A.

FIG. 19 is an exploded perspective view showing the door removed from the cooking apparatus of FIG. 15.

FIG. 20 is a side view of the cooking apparatus of FIG. 15.

FIG. 21 is an exploded perspective view of the latch of the cooking apparatus of FIG. 20.

FIG. 22 is a top view of the latch housing of the cooking apparatus of FIG. 21.

FIG. 23 is a cross-sectional view of the cooking apparatus of FIG. 15.

FIG. 24 is an enlarged cross-sectional view of the indicated portion of FIG. 23.

### DETAILED DESCRIPTION

The embodiments described herein and the configurations illustrated in the drawings are merely examples of the disclosed invention, and there are many variations that may be substituted for the embodiments and drawings described herein at the time of filing of this application.

In addition, identical or similar reference numerals or symbols in each drawing of this specification designate parts or components that perform substantially the same function.

Further, the terminology used herein is intended to describe embodiments and is not intended to limit and/or define the disclosed invention. The singular expression includes the plural unless the context clearly indicates otherwise.

Within the Figures and the text of the disclosure, a reference number indicating a singular form of an element may also be used to reference a plurality of the singular element.

In this specification, the terms “comprises,” “includes” or “has” and the like are intended to designate the presence of the features, numbers, steps, actions, components, parts, or combinations thereof described, and do not preclude the possibility of the presence or addition of one or more other features, numbers, steps, actions, components, parts, or combinations thereof.

Further, as used herein, ordinal terms such as “first,” “second,” and the like may be used to describe various components, but the components are not limited by such terms, and such terms are used only to distinguish one component from another. For example, without departing from the scope of the present invention, a first component may be named a second component, and similarly, a second component may be named a first component.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” The term “and/or” includes any combination of a plurality of related recited items or any one of a plurality of related recited items.

As used in the following description, the terms “up and down,” “bottom,” and “front and rear” are defined with reference to the drawings, and the shape and position of each component are not limited by these terms.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The cooking apparatus 1 according to one embodiment of the present invention is described using a microwave oven as an example. However, without limitation, the cooking apparatus 1 according to one embodiment of the present invention may also be applied to other cooking apparatus 1, such as an oven.

Embodiments of the present invention will be described in detail below.

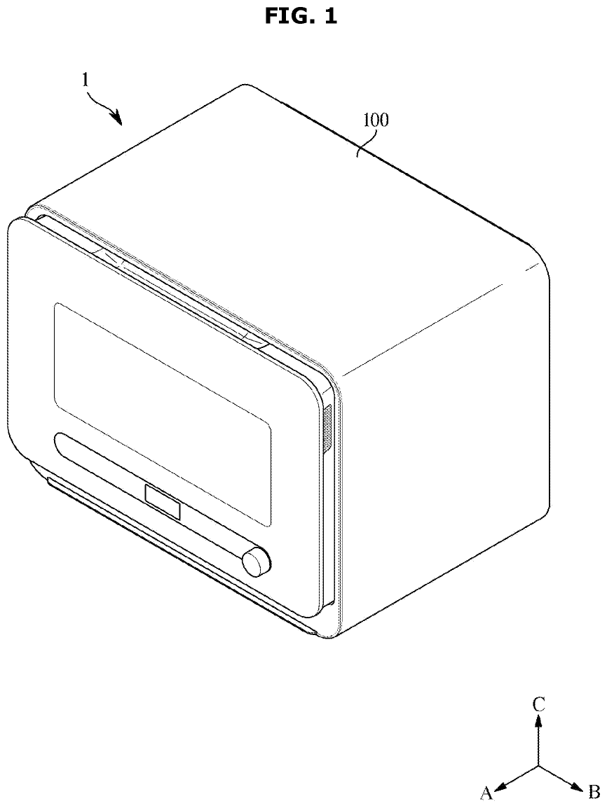

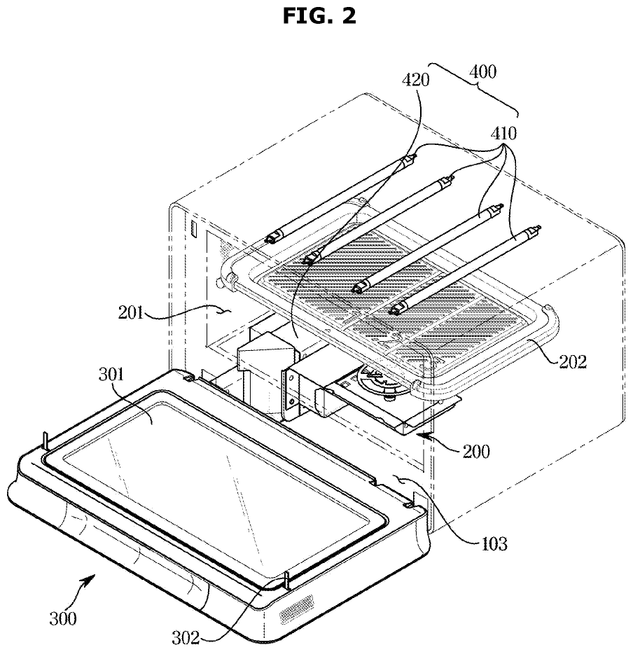

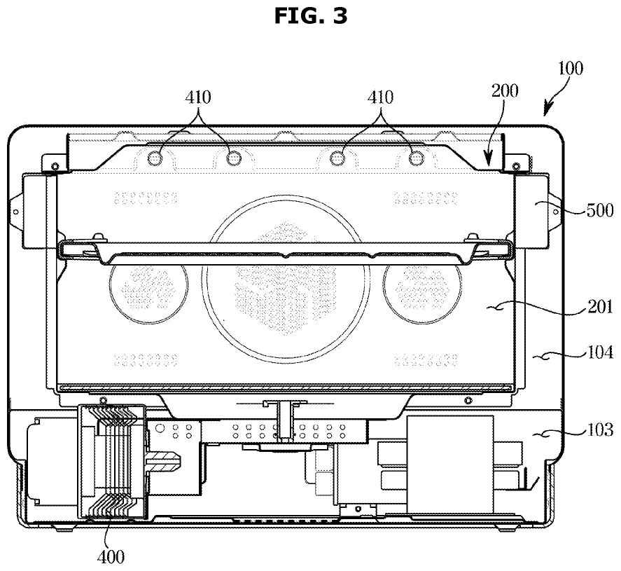

FIG. 1 is a perspective view illustrating the exterior of a cooking apparatus 1 according to one embodiment of the present disclosure. FIG. 2 is a perspective view illustrating a partial configuration of the interior of the cooking apparatus 1 shown in FIG. 1. FIG. 3 is a cross-sectional view of FIG. 1 cut along a plane parallel to the front panel 120 from the inside of the door 300.

As shown in FIGS. 1 and 2, a cooking apparatus 1 may include an outer housing 100 forming or providing an exterior of the cooking apparatus 1, and an inner housing 200 disposed inside the outer housing 100 and forming a cooking room 201. The cooking room 201 may be a cooking space or volume space in which an object may be disposed for heating, cooking, etc. The cooking room may be exposed to outside the cooking apparatus 1 or separated from the outside by operation of the door 300.

Referring to FIGS. 1 to 3, a front of the cooking apparatus 1 may be defined in the A direction, while a rear of the cooking apparatus 1 is opposite to the front in the direction opposite to the A direction. Sides of the cooking apparatus 1 may be provided opposite to each other along the B direction. A top of the cooking apparatus 1 may be defined in the C direction, while a bottom thereof is provided opposite to the top in the direction opposite to the C direction. A thickness of the cooking apparatus 1 and/or various components or layers thereof, may be defined along the C direction to define a thickness direction. The view of FIG. 3 may be a view of the plane defined by the B direction and the C direction crossing each other, that is, a view along the A direction.

The outer housing 100 and the inner housing 200 may be arranged to open toward the front of the cooking apparatus 1. That is, both of the housings may open in a front direction (e.g., in the A direction).

A user may place a food item into the cooking room 201 or remove a food item from the cooking room 201, through an opening (e.g., a first opening) in the inner housing 200. The outer housing 100 may have an opening (e.g., a second opening) corresponding to the first opening.

The cooking room 201 may be arranged in a roughly cuboidal shape, that is, having a cuboidal volume.

The cooking apparatus 1 may include a machine room 103 formed inside the outer housing 100 and disposed below the cooking room 201. Inside the machine room 103, various electrical components that drive the cooking apparatus 1 may be disposed.

The cooking apparatus 1 may include a door 300 arranged to be openable and closable to open and close a respective opening in the outer housing 100 and the inner housing 200.

The door 300 may include a key door 302 as a door key that secures the door 300 to other components of the cooking apparatus 1.

On the front side of the door 300, an input portion or manipulation portion may be arranged to input signals (e.g., an electrical signal, a manual signal, etc.) for a user to control the cooking apparatus 1. The input portion or manipulation portion 800 may include a display portion that displays an image or a touch portion that is arranged to input an electrical signal by touching the image.

The door 300 may include a transparent member 301 that is arranged to allow a user to observe the interior of the cooking room 201 when the door 300 is closed.

The cooking apparatus 1 may include a shelf 202 mounted inside the cooking room 201 and arranged for a user to position a cooked item. The shelf 202 may be removably disposed within the cooking room 201.

The cooking apparatus 1 may include a heating source 400 that provides heat to the interior of the cooking apparatus 1, at the cooking room 201, so that the food is cooked by the heat.

The heating source 400 may be arranged to provide heat to the food items located on the shelf 202 so that the food items may be cooked. Additionally, the food items may be located on the bottom of the cooking room 201 without the shelf 202. In this case, the heating source 400 may also provide heat to the cookware located on the bottom.

The heating source 400 may include a first heating source 410 disposed on a top surface of the cooking room 201.

The heating source 400 may include a second heating source 420 disposed on the underside of the cooking room 201. The first heating source 410 may face the second heating source 420 with a portion of the cooking room 201 therebetween.

The first heating source 410 may include a plurality of heaters that generate radiant heat. The plurality of heaters may radiate heat generated by themselves and transfer heat directly to the food product.

The second heating source 420 may include a magnetron that generates high frequencies. The high frequency generated by the magnetron may be injected into the interior of the food product and arranged to cook the interior of the food product by frictional heat between the molecules generated by repeatedly converting the molecular arrangement of the water contained in the food product.

The magnetron may be disposed in the machine room 103. A second heating source 420 may oscillate a high frequency from the machine room 103 toward the underside of the cooking room 201 and the high frequency may pass through the underside and be irradiated onto the shelf 202.

The cooking apparatus 1 may include a first heating source 410 and a second heating source 420, and may be arranged to efficiently cook a food product.

As shown in FIG. 3, the cooking apparatus 1 may include a predetermined separation space 104 between the inner housing 200 and the outer housing 100.

The separation space 104 may be provided with a latch 500. The latch 500 may be located at the front upper side of the separation space 104. The latch 500 may be formed in two symmetrical rows on the back of the front panel 120 of the outer housing 100. The latch 500 may engage with the door 300, at the key door 302, to secure the door 300 so that the door 300 cannot be opened.

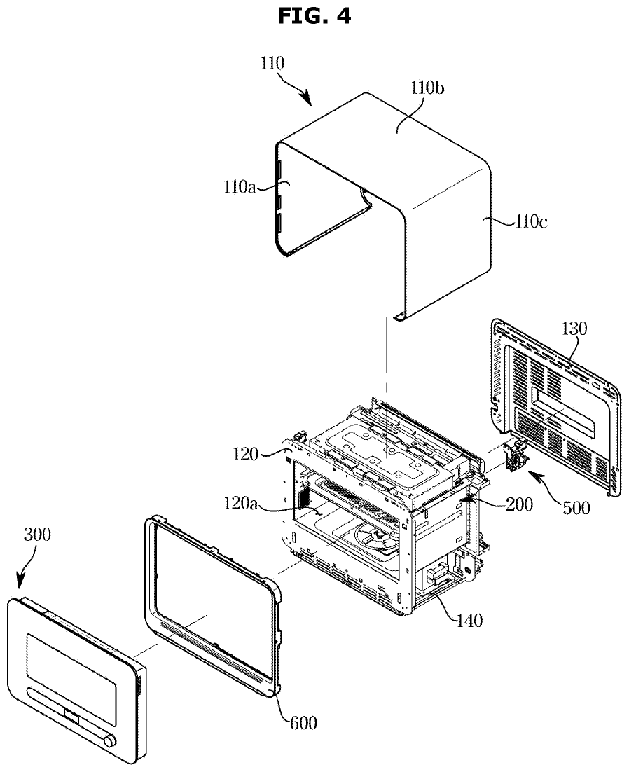

FIG. 4 is an exploded view of the cooking apparatus 1 shown in FIG. 1.

As shown in FIG. 4, the cooking apparatus 1 may include a door 300, a cover member 600, an outer housing 100, an inner housing 200, and a latch 500.

The cover member 600 may be located between the door 300 and the outer housing 100.

A detailed positioning relationship and function of the cover member 600 will be described later.

The outer housing 100 of the cooking apparatus 1 may include an upper panel 110b and both side panels 110a, 110c, a front panel 120, a back panel 130, and a bottom panel 140. The upper panel 110b and the two side panels 110a, 110c may be integrally formed.

The front panel 120 may be coupled to the front of the inner housing 200. The front panel 120 may serve to cover the front of the machine room 103, prevent electrical components from being exposed to the outside, and protect the inner housing 200. At this time, a cooking room opening 120a may be formed in or by portions of the front panel 120, such that cooking items may be placed inside the cooking room 201 through the cooking room opening 120a.

The housing cover 110 may be integrally formed including an upper panel 110b and two side panels 110a, 110c. The housing cover 110 may function to protect the cooking apparatus 1 from the outside.

The back panel 130 may be coupled to the back of the inner housing 200, and may function to protect electronics by preventing them from being exposed to the outside. In particular, the back of the inner housing 200 may have shock-sensitive electronics, such as a printed circuit board (PCB), which may be protected.

The latch 500 may be coupled to the outer housing 100 at the front panel 120.

Specifically, the latch 500 may be coupled to a back surface of the front panel 120. More specifically, the latch 500 may be coupled to a top side portion of the back surface of the front panel 120.

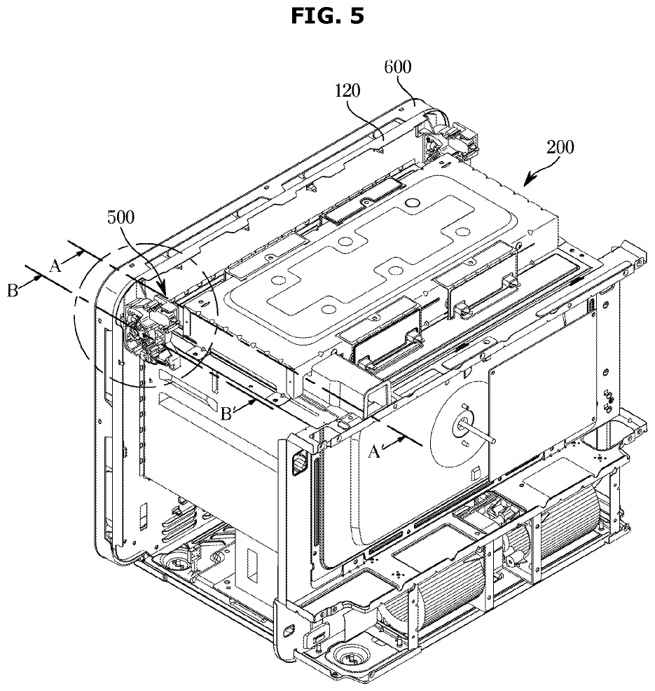

FIG. 5 is a perspective view from the rear with the outer housing 100 of the cooking apparatus 1 of FIG. 1 removed.

As shown in FIG. 5, the latch 500 may be coupled to the back of the front panel 120.

The latch 500 not only serves to secure the door 300, but also serves to detect a position of the door 300 in the opening and closing of the door 300. Therefore, the latch 500 is coupled to a location that allows the latch to detect the opening (or closing) of the door 300 as accurately as possible.

In the case of a cooking apparatus 1 using a magnetron, care must be taken to ensure that the high frequencies generated by the magnetron do not come into contact with a living body such as the human body, since the high frequencies can cause harmful effects if they come into contact with the human body. For this reason, international standards exist to ensure that the cooking apparatus 1 with a magnetron does not leak high frequencies when the door 300 is opened.

In other words, the cooking apparatus 1 must be able to accurately detect when door 300 is opened, so that generation of high frequencies in the magnetron when door 300 is opened can be prevented. To accomplish this, the latch 500 must be accurately engaged in its intended position so that it can accurately detect the opening of the door 300.

The present invention couples the latch 500 to the back of the front panel 120 of the outer housing 100 so that the latch 500 more accurately detects the opening and closing of the door 300. Since the latch 500 is coupled to the back of the front panel 120, the distance to the door 300 is constant with the thickness of the front panel 120, the engagement position of the latch 500 can be constant, e.g., the latch 500 can be positioned in the intended location.

Thus, based on this precise location, it is possible to more accurately measure the opening of the door 300. When the door 300 is opened, the blocking of the high frequency occurs precisely, thereby providing a safer cooking apparatus 1 and producing a product that complies with international standards.

Further, by directly coupling the latch 500 to the front panel 120 of the outer housing 100, the process of re-adjusting the position of the latch 500 after coupling the latch 500 may be eliminated. For example, in an embodiment of a method of providing the cooking apparatus 1, when coupling the latch 500 to the inner housing 200, a process of re-adjusting the spacing of the front and rear of the latch 500 while the latch 500 is coupled to the inner housing 200 is performed. However, when coupling the latch 500 to the outer housing 100 as in the present invention, such a process is unnecessary, which may reduce manufacturing time and cost.

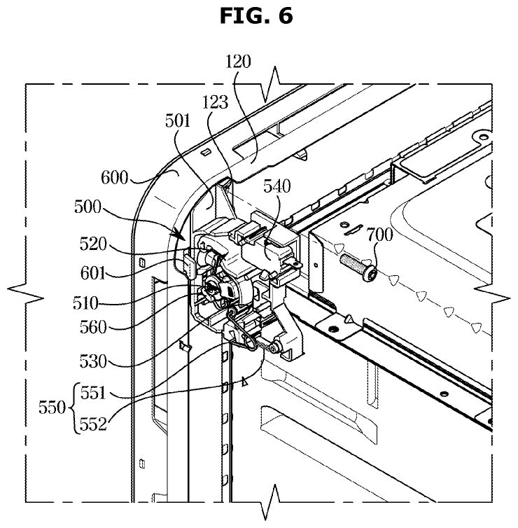

FIG. 6 is an enlarged perspective view of the latch 500 of the cooking apparatus 1 of the present disclosure. FIG. 6 is an enlarged perspective view of the latch 500 shown in the indicated portion of FIG. 5.

As shown in FIG. 6, the latch 500 is coupled to the back of the front panel 120 by a coupling member 700. The coupling member 700 may be a screw. However, unlike the present embodiment, the coupling member 700 may include any other engaging mechanical element, such as a pin, key, rivet, bolt, or the like, that may be penetrated or inserted into the plurality of components to engage the plurality of components. The coupling member 700 may penetrate the latch 500 and the front panel 120 to couple the latch 500 and the front panel 120. At this time, an end of the coupling member 700 may protrude toward the front of the cooking apparatus 1. A cover member 600 may be coupled to the front side of the front panel 120, such that the coupling member 700 through the latch 500 and the front panel 120 may be fastened to the cover member 600. Thus, the latch 500 and the coupling member 700 penetrating the front panel 120 may be covered by the cover member 600 and not exposed.

The cover member 600 may include a latch guide 601 having a protruding shape. When the cover member 600 is coupled to the front of the front panel 120, the latch guide 601 may be inserted into a latch guide hole 121 formed in the front panel 120. The latch guide 601 may be received in the latch guide hole 121. The latch guide 601 may be located on a side of the latch 500 to prevent side-to-side movement of the latch.

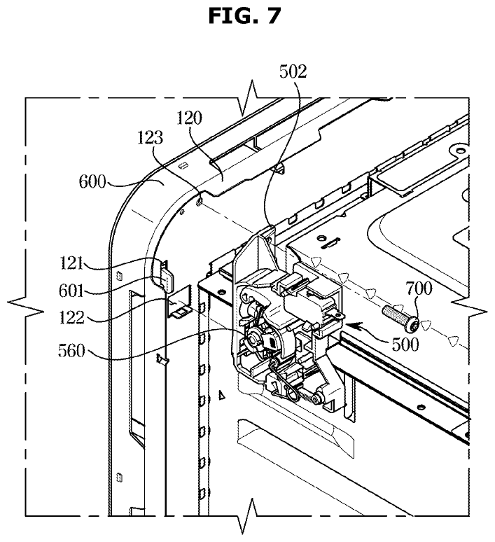

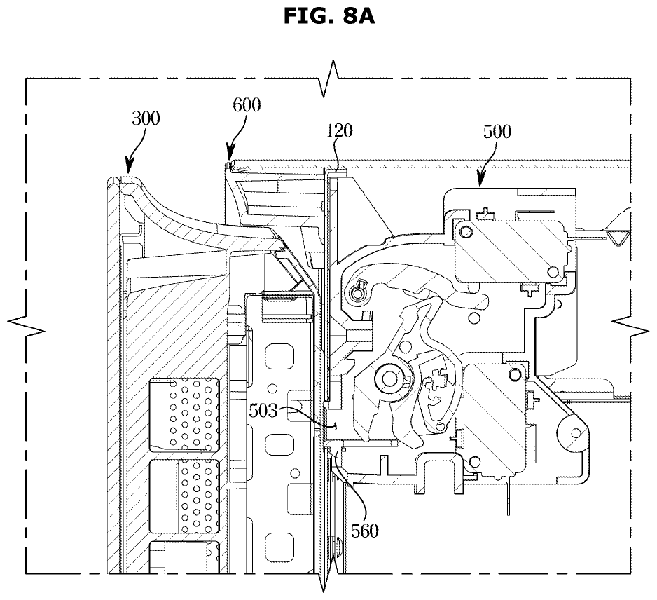

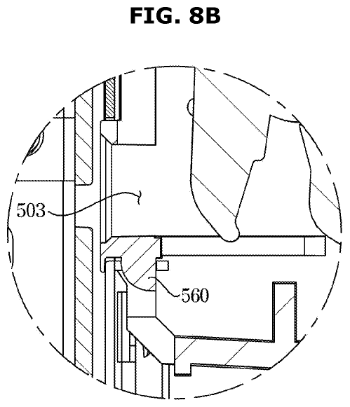

FIG. 7 is an exploded view of the latch 500 and coupling member 700 in the enlarged perspective view of FIG. 6. FIGS. 8A and 8B are cross-sectional views of the latch 500 of the cooking apparatus 1 of FIG. 5 cut in the A-A′ plane.

As shown in FIGS. 7 and 8, the latch 500 may include a latch restrictor 560, which is a protruding shape with bent ends. The front panel 120 may include a front panel key door opening 122 corresponding to the latch restrictor 560. The latch restrictor 560 may be received in the front panel key door opening 122. The latch 500 may not be easily separated from the front panel 120 by the bent end of the latch restrictor 560. When coupled in this manner, the latch 500 is not easily separated from the front panel 120.

In summary, the latch 500 may be coupled to the front panel 120 such that it is immobilized by the coupling member 700, the latch guide 601, and the latch restrictor 560.

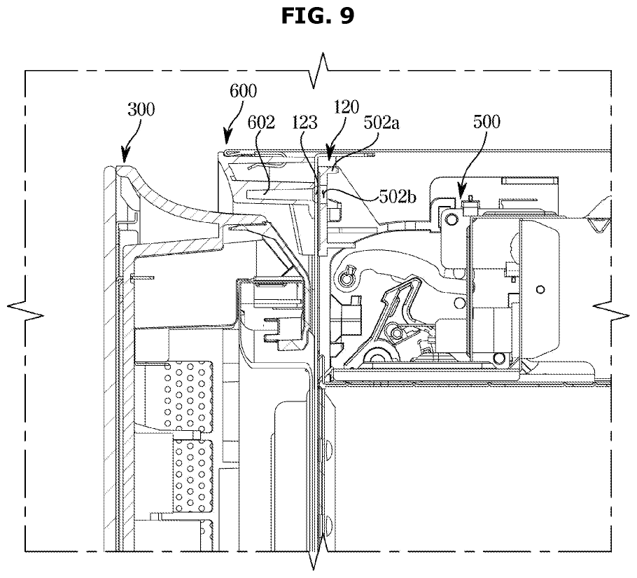

FIG. 9 is a cross-sectional view of the latch 500 of the cooking apparatus 1 of FIG. 5 cut from another plan′ B-B′. Referring to FIG. 5, the plane B-B′ is spaced apart from the plane A-A′ along the B direction.

As shown in FIG. 9, it can be seen how the coupling member 700 described in FIG. 6 is coupled to the front panel 120 and the cover member 600.

The latch 500 may include a bracket 502a projecting from a back surface of the front panel 1120, and a bracket opening 502b may be formed in the bracket 502a for the coupling member 700 to penetrate.

A front panel coupling opening 123 is also formed in the front panel 120 to correspond to the passage of the latch 500, through which the coupling member 700 can pass.

The coupling member 700 is coupled through the coupling opening 502 formed in the latch 500 and the front panel coupling opening 123 formed in the front panel 120, thereby allowing the latch 500 and the front panel 120 to be coupled to each other. That is, the coupling opening 502 and the front panel coupling opening 123 may be aligned with each other such that the coupling member 700 extends therethrough.

The cover member 600 may include a fastening groove 602 to which the coupling member 700 is fastened. Since the fastening groove 602 may receive an end (e.g., a distal end_ of the coupling member 700, the coupling member 700 may not be exposed at the front of the cover member 600. Since the end of the coupling member 700 does not protrude outwardly from the cover member 600 in the front direction, aesthetics may be improved and stability may be enhanced.

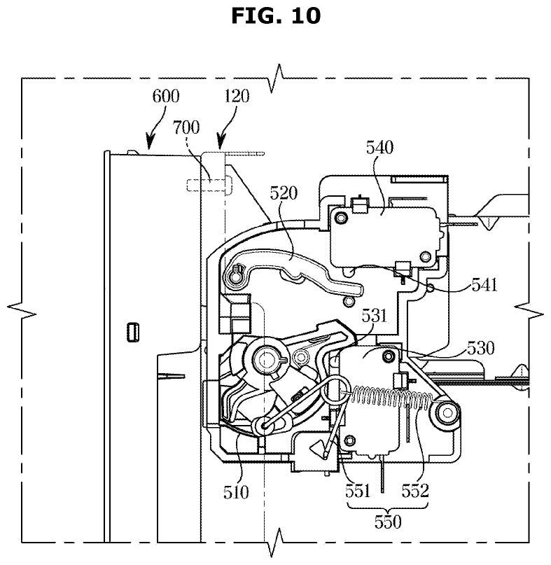

FIG. 10 is a side view of a latch 500 of the cooking apparatus 1 when the door 300 is in the open state. FIG. 10 may be a view along the B direction.

As shown in FIG. 10, the latch 500 includes a latch housing 501 that forms an exterior of the latch 500. The latch 500 may include a latch lever 510, 520 inside the latch housing 501. The latch levers 510, 520 may be rotatably coupled with the latch housing 501. The latch levers may include a first latch lever 510 and a second latch lever 520. The first latch lever 510 and the second latch lever 520 may be interactively operable. The latch 500 can include an elastic member 550 coupled to the latch levers 510, 520. The elastic member 550 may bias a position of the levers to allow the latch levers 510, 520 to return to their original positions. The latch 500 may include a detecting member as a detector provided in plural including detecting members 530, 540 that detect the opening of the door 300. The detecting portion can be any type of sensor, but will be described herein with reference to a button-shaped detecting portion. Two such detecting elements 530, 540 may be formed in the latch 500. The detecting portion corresponding to the first latch lever 510 may be referred to as the first detecting portion 530, and the detecting portion corresponding to the second latch lever 520 may be referred to as the second detecting portion 540.

The detecting members 530, 540 may include detecting buttons 531, 541. The detecting portion button formed on the first detecting portion 530 may be referred to as the first detecting portion button 531, and the detecting portion button formed on the second detecting portion 540 may be referred to as the second detecting portion button 541.

If there is only one detecting part 530, 540, the detecting part 530, 540 may be activated not only by the opening and closing of the door 300, but also by artificially manipulating the detecting part 530, 540. To prevent such malfunctions, the detecting elements 530, 540 may be formed in two latch 500 s to detect only the opening and closing of the door 300. Two latches 500 may be formed symmetrically on the back of the front panel 120, and only one latch 500 may have two detecting portions formed thereon, while the other latch 500 may have only one detecting portion formed thereon. Here, both latches 500 can perform the aforementioned functions without having two detecting portions.

Describe how latch 500 works.

Referring to FIG. 10, in the open state of the door 300, the first latch lever 510 is in the lowered state, and the second latch lever 520 is also in the lowered state. In the electronic device 1 including the door 300 which is opened, the latch levers 510, 520 are being forced to rotate about an axis, downward by the bias force of the elastic member 550 coupled to the latch levers 510, 520. In this case, the detecting buttons 531, 541 included in the detecting members 530, 540 remain unpressed.

The elastic member 550 may include a first elastic member 551 and a second elastic member 552 which is coupled to an end of the first elastic member 551 to efficiently hold the first latch lever 510 biased in a lowered state. The elastic member 550 may further include a third elastic member 553 located adjacent a first end of the first latch lever 510 and a second end of the second latch lever 520 and elastically biased in a direction to lower the second latch lever.

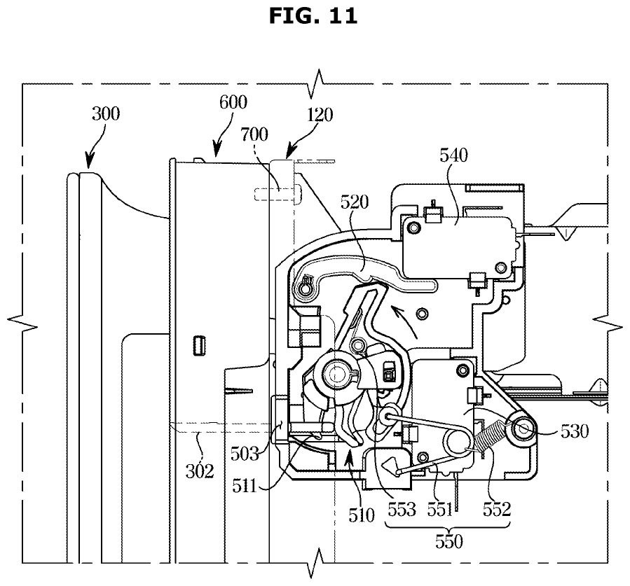

FIG. 11 is a side view of a latch 500 of the cooking apparatus 1 when the door 300 is in the closed state.

As shown in FIG. 11, in the closed state of door 300, first latch lever 510 is rotated about the axis in a counter-clockwise direction from FIG. 10, to be in the raised state, and second latch lever 520 is also in the raised state by rotation in the counter-clockwise direction. As the door 300 closes, the key door 302 protruding from the rear of the door 300 may be inserted into the latch restrictor groove 560. The key door 302, which has entered the interior of the latch housing 501 through the latch restrictor groove 560, may depress the first latch lever 510. Thereby, the first latch lever 510 may be forced to rotate upwardly. As the first latch lever 510 rotates upward, the second latch lever 520 can be pressed upward. The second latch lever 520 may thereby be rotated upwardly.

The first latch lever 510 can be rotated upward to press first detecting section button 531 included in first detecting section 530. The second latch lever 520 can rotate upward and press the second detecting portion button 541 included in the second detecting portion 540. A control portion (not shown) of the cooking apparatus 1, which is connected to the sensor described above, may determine that the door 300 is in a closed state when the first detecting portion button 531 and the second detecting portion button 541 are pressed together with each other. The control portion of the cooking apparatus 1 may be a controller, a processor, a computer or other electronic device including the controller, etc., without being limited thereto. Determination of opening or closing of the door 300 may use a method of detecting changes in capacitance within the latch 500, without being limited thereto.

When the door 300 is in the open state, the key door 302 exits or is retracted from the latch 500 through the latch restrictor groove 560. This retraction causes the first latch lever 510 to rotate downward (e.g., in a clockwise direction), the second latch lever 520 to rotate downward, and the detecting buttons 531, 541 to return to their un-depressed state. In this way, the open state of the door 300 can be detected. When the open state of the door 300 is detected, the generation of the high frequency may be blocked.

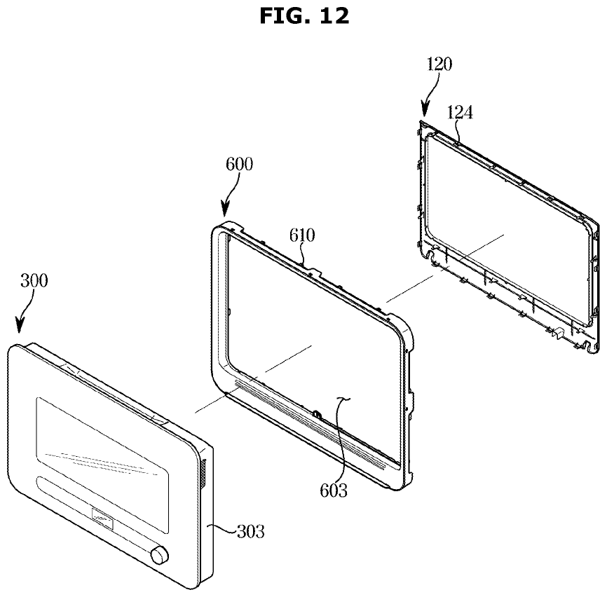

FIG. 12 is a perspective view illustrating a door 300, a cover member 600, and a front panel 120 of a cooking apparatus 1.

As shown in FIG. 12, the cover member 600 may include a cover member protrusion 610 having a protruding shape relative to a main body of the cover member 600. A cover member protrusion groove 124 may be formed in the front panel 120 at a location corresponding to the cover member protrusion 610. Thus, by insertion or engagement of the cover member protrusion 610 of the cover member 600 into the cover member protrusion groove 124 of the front panel 120, the cover member 600 may be coupled to the front panel 120.

The cover member 600 may be formed in a roughly square frame shape, e.g., the cover member 600 may define or include a cover member opening 603. When the door 300 is in the closed state, a portion of the door 300 may be received in the cover member opening 603. When the door 300 is in the closed state, the cover member 600 may be formed to enclose a portion of the door side 303.

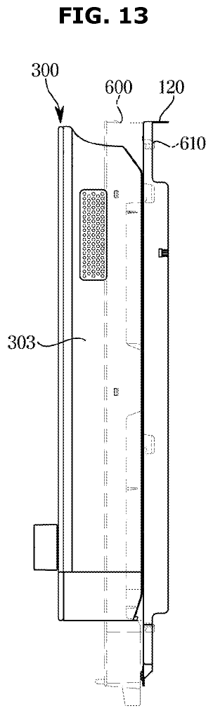

FIG. 13 is a side view showing the door 300, cover member 600, and front panel 120 of the cooking apparatus 1 of FIG. 12 combined with each other.

As shown in FIG. 13, the cover member 600 may be formed to receive a portion of the door side 303. Since a portion of the door 300 is obscured by the cover member 600, a user may perceive the door 300 as having a thickness in the A direction that is less than the actual thickness of the door 300. Accordingly, the design of the cooking apparatus 1 of the present invention may be improved.

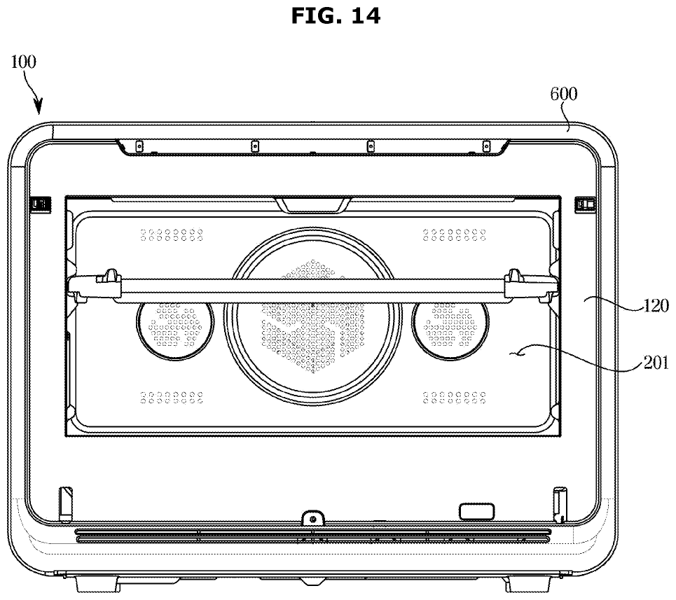

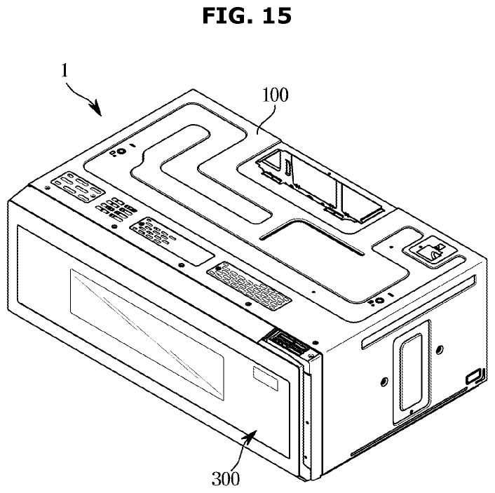

FIG. 14 is a front view of the present cooking apparatus 1, excluding the door 300. As shown in FIG. 14, the end of the coupling member 700 is concealed by the cover member 600. As such, the cover member 600 can provide the cooking apparatus 1 with improved aesthetics and stability by making the end of the coupling member 700 invisible.

Other embodiments of the present invention will be described in detail below.

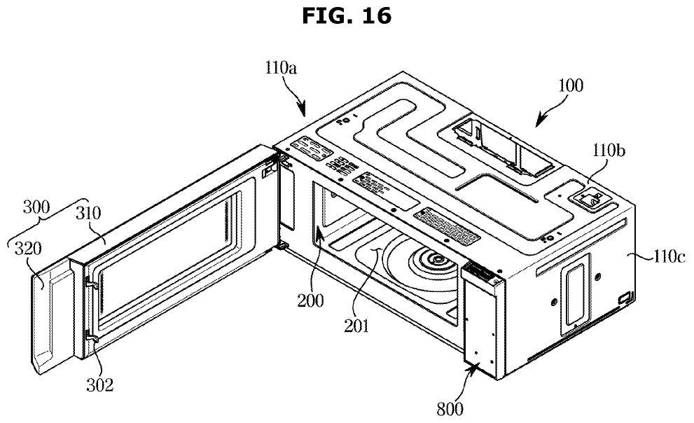

FIG. 15 is a perspective view illustrating an exterior view of the cooking apparatus 1 according to an embodiment of the present disclosure.

As previously described, in the form shown in FIG. 15, the cooking apparatus 1 may include an outer housing 100 forming an exterior of the cooking apparatus 1, and a door 300 that rotatably engages the outer housing 100 and, when closed, conceals a front surface of the outer housing 100.

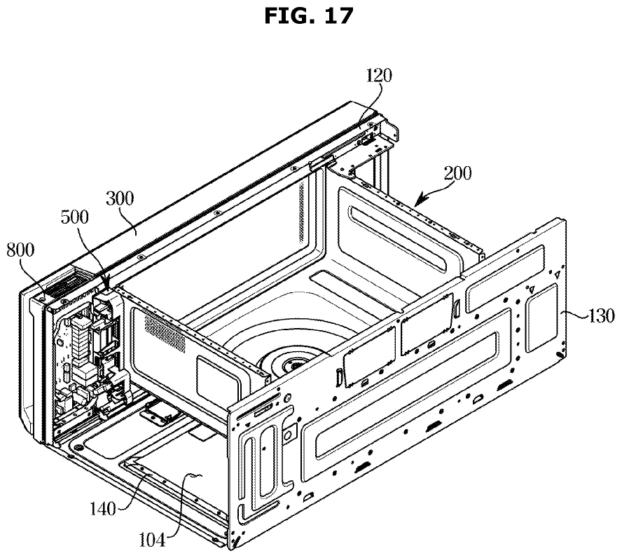

FIG. 16 is a perspective view illustrating a state in which the door 300 of the cooking apparatus 1 disclosed in FIG. 15 is open.

As shown in FIG. 16, the outer housing 100, which constitutes the exterior of the cooking apparatus 1, and the inner housing 200 which is disposed inside the outer housing 100, may be arranged to be open toward the front of the cooking apparatus 1.

The outer housing 100 may have a roughly cuboidal shape that includes a front panel 120, an upper panel 110b, side panels 110a, 110c, a back panel 130 (FIG. 17), and a bottom panel 140 (FIG. 17).

In this case, the door 300 may be rotatably coupled to the front panel 120 of the outer housing 100 to open and close a collective opening in the outer housing 100 and the inner housing 200.

The cooking apparatus 1 may include a manipulation portion 800 coupled to a front of the front panel 120 of the outer housing 100. The manipulation portion 800 of the cooking apparatus 1 allows a user to provide input to the cooking apparatus 1 to perform various operations of the cooking apparatus 1. The manipulation portion 800 is coupled to the front of the outer housing 100, so that a portion of the front panel 120 can be hidden from view from the outside. To avoid hiding the cooking room 201, the manipulation portion 800 may be coupled to a portion of the front panel 120 that does not correspond to the cooking room 201, that is, to a side portion of the front panel 120, along the B direction. That is, the manipulation portion 800 through which an input is provided to the cooking apparatus 1 may cover

Since the door 300 can be rotated from the front of the outer housing 100 to conceal the front panel 120 of the outer housing 100, the manipulation portion 800 that engages with the front panel 120 from the front of the outer housing 100 can also be concealed. In this case, since the manipulation portion 800 protrudes toward the front of the cooking apparatus 1 more than the front panel 120, the door 300 may include a manipulation portion door 320 to receive and hide the manipulation portion 800, and a cooking room door 310 to face and hide the cooking room 201, corresponding to the shape of the manipulation portion 800. In other words, the door 300 may have a flat shape across an entire width of the cooking apparatus 1 along the B direction, when viewed from the front, so that the manipulation portion door 320 may be formed with a thickness less than the thickness of the manipulation portion 800.

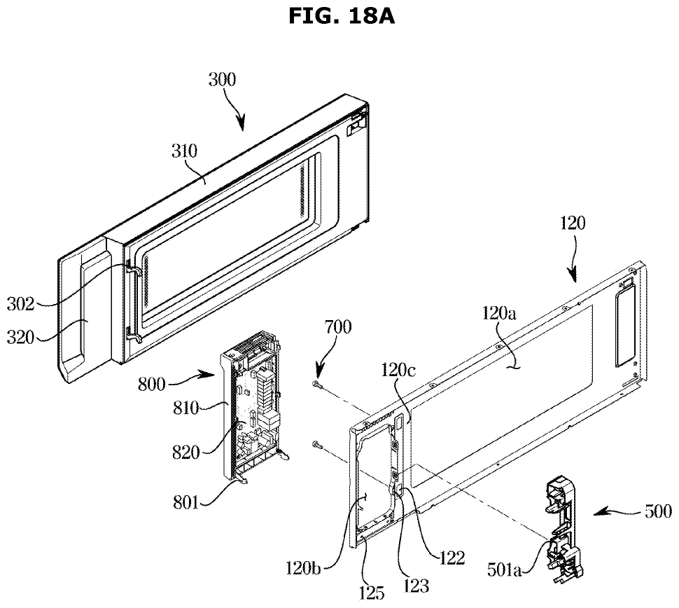

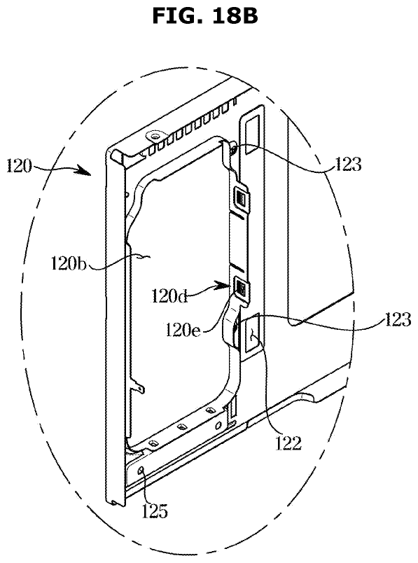

The door 300 may include a key door 302. The key door 302 may include a shape that protrudes toward the rear of the cooking apparatus 1 when the door 300 is in the closed state. The key door 302 may interact with the latch 500, which will be described later, to detect opening and closing of the door 300 of the cooking apparatus 1. The key door 302 will be described in more detail later with reference to FIGS. 18A and 18B.

FIG. 17 is a rear perspective view of the cooking apparatus 1 of FIG. 15, with the upper panel 110b (FIG. 16) and the two side panels 110a (FIGS. 16, 110c) of the outer housing 100 and the top panel (not shown) of the inner housing 200 removed.

As shown in FIG. 17, a predetermined separation space 104 or gap may be provided between the outer housing 100 and the inner housing 200. The separation space 104 may be provided on or at the back side of the front panel 120. In the separation space 104, various electrical components (not shown) necessary for operation of the cooking apparatus 1 may be located.

A manipulation portion 800 may be coupled to the front of the front panel 120 of the outer housing 100. A manipulation portion opening 120b may be formed in the front panel 120 corresponding to the portion to which the manipulation portion 800 is coupled. The manipulation portion opening 120b may be an enclosed opening in a plan view (e.g., a view along the A direction of the plane defined in the B-C directions), which is provided or defined by portions of front panel 120. Through the manipulation portion opening 120b, the manipulation portion 800 may be connected to an internal electrical appliance (not shown).

The manipulation portion 800 may be coupled to the front panel 120 with the manipulation portion opening 120b hidden. The manipulation portion 800 may cover the front of the separation space 104, thereby preventing the electronics from being exposed to the outside and protecting the inner housing 200.

In this case, when the manipulation portion 800 is coupled to the front panel 120, the manipulation portion 800 may protrude toward the back surface of the front panel 120 through the manipulation portion opening 120b formed in the front panel 120. In this case, the manipulation portion 800 may protrude toward the separation space 104 formed on or at the back surface of the front panel 120.

At the back surface of the front panel 120 of the outer housing 100, the front panel 120 may be coupled with a latch 500 that interacts with the key door 302 formed in the door 300 to detect opening and closing of the door 300. In this case, the latch 500 may protrude toward the separation space 104 formed at the back surface of the front panel 120.

In other words, the separation space 104 may house the detecting portion 800 and the latch 500.

FIG. 18A is a rear perspective view illustrating the door 300, manipulation portion 800, front panel 120, and latch 500 of the cooking apparatus 1 of FIG. 15, and FIG. 18B is an enlarged view of the indicated portion of FIG. 18A.

As shown in FIG. 18A, the front panel 120 may include a cooking room opening 120a provided in a position corresponding to the cooking room 201, and a manipulation portion opening 120b provided in a position corresponding to the manipulation portion 800. Through the cooking room opening 120a, a user can place a cooked item inside the cooking room 201. Furthermore, the manipulation portion opening 120b may be used to connect the manipulation portion 800 to an electrical appliance (not shown).

A door 300 may be positioned on front of the front panel 120. On the front side of the front panel 120, a manipulation portion 800 may be positioned. The manipulation portion 800 may be positioned between the front panel 120 and the door 300, so that a rear shape of the door 300 may be formed corresponding to a shape in which the manipulation portion 800 protrudes toward the front side of the cooking apparatus 1. Accordingly, the manipulation portion door 320, which is a first portion of the door 300 in a position corresponding to the manipulation portion 800, may be thinner than the cooking room door 310, which is a second portion of the door 300 in a position corresponding to the cooking room 201 and adjacent to the first portion of the door 300.

The door 300 may include a key door 302 protruding in the direction of the latch 500.

The front panel 120 may include a front panel key door opening 122 as a door key opening provided in a position corresponding to the key door 302. The front panel key door opening 122 may be formed larger than a cross-section of the key door 302 to allow the key door 302 to easily move through the front panel key door opening 122. The key door 302 may be able to penetrate the front panel key door opening 122 of the front panel 120, in a direction from the front to the back of the front panel 120, and interact with the latch 500 to detect the opening and closing of the door 300.

A location for the key door 302 of the door 300 may be provided on the side of the cooking room door 310. The manipulation portion 800 is positioned relative to the manipulation portion door 320, so that when the door 300 is in the closed state, the key door 302 may not contact the manipulation portion 800.

A manipulation portion 800 may be coupled to the front of the front panel 120. The manipulation portion 800 may include a manipulation portion cover 810 that forms an exterior of the manipulation portion 800. The manipulation portion cover 810 may be sized to be wider than the width of the manipulation portion opening 120b of the front panel 120. Thus, when the manipulation portion cover 810 is coupled to the manipulation portion opening 120b, the manipulation portion opening 120b may be generally obscured.

The manipulation portion cover 810 may be provided with an inwardly recessed space. A recess may be open at the rear of the manipulation portion cover 810 and recessed in a direction from the front to the rear. A manipulation portion PCB 820, which controls the operation of the manipulation portion 800, may be located in the receiving space of the manipulation portion cover 810. The manipulation portion PCB 820 may be protected from external impact by the manipulation portion cover 810.

The manipulation portion 800 may include a manipulation portion protrusion 801 that protrudes in a direction opposite to the direction facing the manipulation portion cover 810. The manipulation portion protrusion 801 may be provided at the bottom of the manipulation portion cover 810.

The front panel 120 can include a manipulation portion protrusion receiving hole 125 positioned relative to the manipulation portion protrusion 801. The manipulation portion protrusion 801 may be received in the manipulation portion protrusion receiving hole 125 to couple the manipulation portion 800 to the front panel 120. As the manipulation portion protrusion 801 may be provided at the bottom of the manipulation portion cover 810, the manipulation portion protrusion 801 receiving hole 125 may be provided at the bottom of the manipulation portion opening 120b, such as being adjacent to such opening.

The front panel 120 may include an opening connecting portion 120c formed between the cooking room opening 120a and the manipulation portion opening 120b. The opening connecting portion 120c may not be an impenetrable opening, and thus may protect electrical components located on the backside of the opening connecting portion 120c. Both the cooking room opening 120a and the manipulation portion opening 120b may be enclosed openings of the front panel 120, provided by solid portions of the front panel 120. The cooking room opening 120a and the manipulation portion opening 120b may be divided by the opening connecting portion 120c as a solid portion of the front panel 120 which assists in defining the two openings.

The latch 500 may be coupled to a back surface of the front panel 120 by a coupling member 700. The front panel 120 may include a front panel coupling opening 123 through which the coupling member 700 may penetrate. The coupling member 700 can penetrate the front panel coupling opening 123 and engage the latch 500, thereby coupling the latch 500 to the front panel 120. As previously discussed, when the latch 500 is coupled to the back surface of the front panel 120, the opening and closing of the door can be accurately detected.

Specifically, the latch 500 may be coupled to an opening connecting portion 120c of the front panel 120. If the front panel 120 includes a cooking room opening 120a and a manipulation portion opening 120b, there may not be much of a portion of the front panel 120 left for the latch 500 to be coupled to. Therefore, in order for the latch 500 to engage the front panel 120, it may be coupled to the opening connecting portion 120c.

Considering that the latch 500 can be coupled with the coupling member 700 through the front panel opening connecting portion 120c, the front panel coupling opening 123 can be located on or defined in the opening connecting portion 120c. In other words, the front panel coupling opening 123 may be located on the opening connecting portion 120c in the shape of a hole or an enclosed opening.

The key door 302, which is included with the door 300, must interact with the latch 500 when the door 300 is in the closed state, so that the key door 302 can pass through the front panel 120 at a position corresponding to the latch 500. Considering that the latch 500 may be located on the back side of the opening connecting segment 120c, the front panel key door opening 122 of the front panel 120 through which the key door 302 penetrates may also be located on the opening connecting segment 120c.

Since the coupling member 700 engages the front panel 120 and the latch 500 through and through (e.g., such as extending completely through thicknesses of both elements), in general, when the door 300 is in the open state, an end of the coupling member 700 may be visible from the outside. If the ends of the coupling member 700 are visible from the outside, it is easy to separate the coupling member 700 from the cooking apparatus 1, and the cooking apparatus 1 may appear less aesthetically pleasing when the door 300 is opened.

To prevent the phenomenon, the coupling member 700 may be coupled with the front panel 120 and the latch 500 in a position that is obscured by the manipulation portion 800.

Since the manipulation portion 800 is located in front of the manipulation portion opening 120b of the front panel 120, and adjacent to the manipulation portion opening 120b is the opening connecting portion 120c, the front panel coupling opening 123 may be located on the opening connecting portion 120c of the front panel 120.

In other words, a front panel key door opening 122 and a front panel coupling opening 123 may be located on the opening connecting portion 120c.

The latch 500 and the front panel 120 are coupled to each other by the coupling member 700. To make the engagement location more precise, the front panel 120 may include a latch guide 120d. The latch guide 120d may have a shape such that a portion of the opening connecting portion 120c is bent and protrudes in a direction opposite to the direction facing the door 300. Thus, the latch 500 is limited in its movement in the side-to-side direction (e.g., along the B direction) by the latch guide 120d so that it can be positioned in a precise location for engagement with the front panel 120. Once in the correct position, the front panel coupling opening 123 included in the front panel 120 and the coupling opening 502 included in the latch 500 are aligned, and thus can be better engaged by the coupling member 700.

To better engage the latch 500 and the front panel 120, the front panel 120 may include a latch protrusion accommodating hole 120e in a portion of the latch guide 120d. The latch 500 may form a latch protrusion 501a at a location corresponding to the latch protrusion accommodating hole 120e. The latch protrusion 501a may be received in the latch protrusion accommodating hole 120e to better couple the latch 500 to the front panel 120.

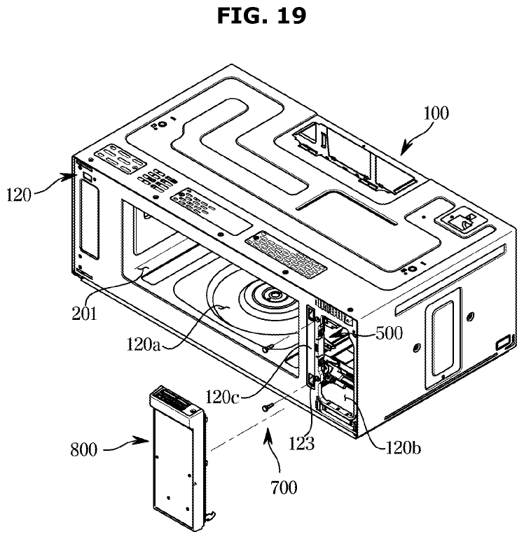

FIG. 19 is an exploded perspective view showing the door 300 removed from the cooking apparatus 1 of FIG. 15.

As shown in FIG. 19, the latch 500 can be located on a back surface of the front panel 120. Specifically, the latch 500 may be located on the back side of the opening connecting portion 120c of the front panel 120. The coupling member 700 may be coupled to the latch 500 through a front panel coupling opening 123 provided on the opening connecting portion 120c. The front panel coupling opening 123 may be provided at a position corresponding to a position where the front panel 120 is covered by the manipulation portion 800. Thus, when the manipulation portion 800 is coupled to the front panel 120, the end of the coupling member 700 may not be visible from the outside.

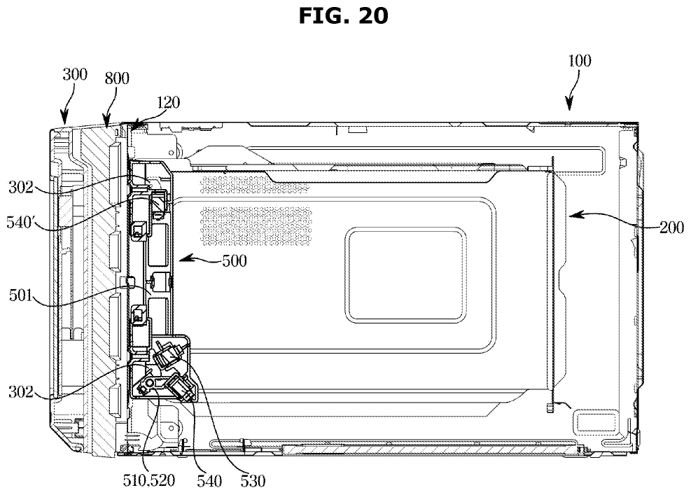

FIG. 20 is a side view of the cooking apparatus 1 of FIG. 15. Referring to FIG. 1 and FIG. 20 may be a view along the direction opposing to the A direction, as a view of the B-C plane.

As shown in FIG. 20, the latch 500 is coupled to the backside of the front panel 120.

In the following, we will briefly discuss the operation of the latch 500.

When the door 300 is in the closed state, the key door 302 enters the latch housing 501 of the latch 500 through the key door opening 503. Inside the latch housing 501, detecting members 530, 540, 540′ may be located. The detecting members 530, 540, 540′ may be a micro switch. The closed state of the door 300 may be detected by the detecting members 530, 540, 540′ when the key door 302 presses the detecting member buttons 531, 541, 541′ of the detecting members 530, 540, 540′ within the latch 500.

While there may be one set of such key doors 302 and detecting members 530, 540, 540′, the invention is not limited thereto. In an embodiment, the cooking apparatus 1 includes a pair of key doors 302 and a pair of detecting members 530, 540, 540′, respectively on the left and right of the apparatus (e.g., along the B direction), or a pair on the top and bottom of the apparatus (e.g., along the C direction), since high frequencies may escape when the door 300 is detected to be closed while the door 300 is warped closed. In the present disclosure, a pair of key doors 302 corresponding to a pair of key door openings 503, and a single set of detecting elements 530, 540, 540′, are used as an example, but are not limited thereto.

If there is one pair of key doors 302 and a corresponding set of detecting members 530, 540, 540′ at positions of the top and bottom of the apparatus, there may be a single one latch housing 501 to accommodate them, or there may be a respective housing configured to accommodate each set within one shape. The present disclosure is illustrated as having one latch housing 501, but is not limited thereto.

The detecting elements 530, 540, 540′ may be present at each position corresponding to the key door 302, but the invention is not limited thereto. In an embodiment, the cooking apparatus 1 may include three detecting members 530, 540, 540′ as safety standards may require at least three detecting members 530, 540, 540′. That is, a detecting element may be provided in plural including a first detecting portion 530, a second detecting portion 540, and a third detecting portion 540′.

Since the key door 302 is positioned correspondingly to at least one of the detecting members 530, 540, 540′, a plurality of latch levers 510, 520 may be required if the key door 302 operates more than one detecting portion. Accordingly, the latch 500 may include the latch leaver provided in plural including the latch levers 510, 520.

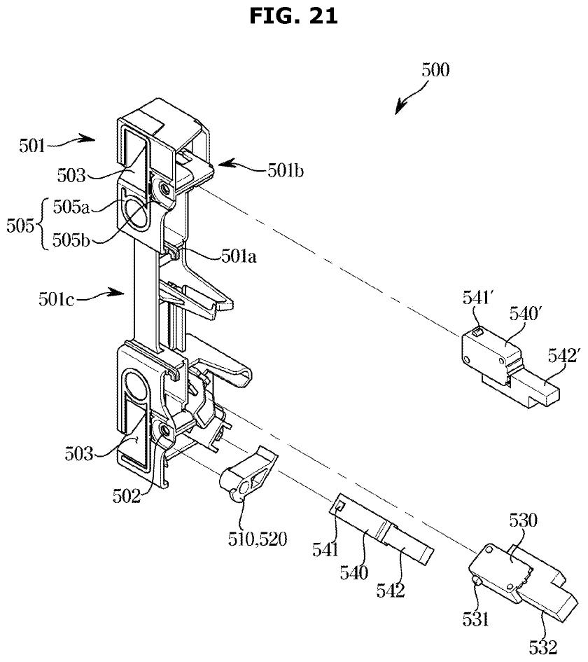

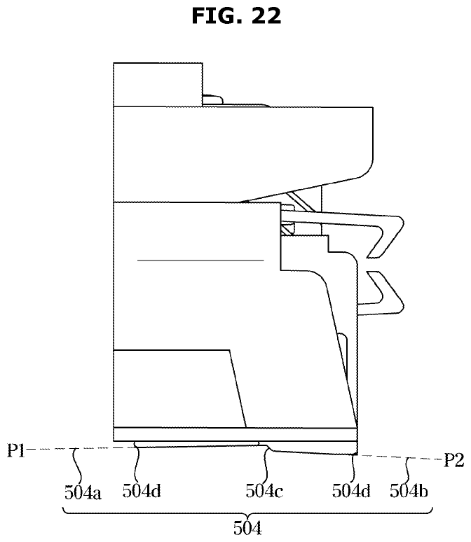

FIG. 21 is an exploded perspective view showing the latch 500 of the cooking apparatus 1 of FIG. 20. FIG. 22 is a top view of the latch housing 501 of the cooking apparatus 1 of FIG. 21.

As shown in FIG. 21, the detecting portion 530, 540, 540′ may respectively include a detecting button 531, 541, 541′. The detecting portion 530, 540, 540′ may respectively include a capacitor 532, 542, 542′ to facilitate operation of the various detecting portions. In other words, the first detecting portion 530 may include the first detecting portion 530 button together with the capacitor 532, the second detecting portion 540 may include the second detecting portion 540 button together with the capacitor 542, and the third detecting portion 540′ may include the third detecting portion 540′ button together with the capacitor 542′. The various buttons may be connected to a respective capacitor to affect detection of opening and closing of the door 300. That is, the controller of the cooking apparatus 1 may use a method of detecting changes in capacitance for determining opening and closing of the door 300, where the controller is connected to the latch and/or one or more of the detectors.

The latch housing 501 can accommodate each of the detecting members 530, 540, 540′. The latch housing 501 may include a latch coupling housing 501b which is a portion in which the detecting members 530, 540, 540′ are variously housed, and a latch supporting housing 501c in which the detecting members 530, 540, 540′ are not housed. When the detecting members 530, 540, 540′ are located in up and down positions, and the upper and lower latch housings 501 are formed as a unit, the latch coupling housing 501b may be located at both of the upper and lower sides, respectively, and the latch supporting housing 501c may be located between them and coupled to the respective latch coupling housings 501b.

When the door 300 is in a closed state, the key door 302 must contact the detecting members 530, 540, 540′ housed inside the latch housing 501 so that the detecting members 530, 540, 540′ can recognize the closed state of the door 300. As such, the key door opening 503 formed inside the latch housing 501 can be located on the latch coupling housing 501b. As being in contact, elements may form an interface therebetween, without being limited thereto.

It is by the interaction of the key door 302 and the detecting members 530, 540, 540′ that the latch 500 recognizes the closed state of the door 300. Therefore, for accurate detection, the distance between the detecting parts 530, 540, 540′ and the key door 302 must be accurately calculated. For this purpose, the coupling opening 502, which is the part to which the coupling member 700 is coupled, is located on the latch coupling housing 501b.

If the coupling opening 502 is located in the latch coupling housing 501b, the latch supporting housing 501c connecting the latch coupling housings 501b to each other need not be located adjacent to the door front panel 120 for the latch 500 to function. Therefore, the latch supporting housing 501c may have a concave shape in a direction away from the front panel 120. This may reduce the amount of material required to manufacture the latch 500, thereby lowering the manufacturing cost.

The side of the latch housing 501 facing the front panel 120, and the front panel 120, are adjacent to each other, so that the latch 500 and the front panel 120 are engaged with each other. In this case, the side of the latch housing 501 facing the front panel 120 may form a latch recess 504 concave in a direction opposite to the direction facing the front panel 120.

The latch housing 501 may be formed by a plastic injection to be a plastic injected member. When the latch housing 501 and the front panel 120 are engaged with each other, if the latch housing 501 is a plastic injected member, the latch housing 501 may be deformed or change shape due to the engagement force. In other words, the latch housing 501 on the side where the coupling member 700 engages may be squashed in shape and may engage the front panel 120 closer than originally intended.

In this case, if the location where the coupling member 700 is to engage the latch housing 501 is near the left and right center axis of the latch 500 when viewed from the left and right, then engaging close to that portion of the latch 500 may only move the left and right ends of the latch 500 away from the front panel 120. In this case, since the detecting portion is located near the left and right center axes of the latch 500, it does not affect where the detecting portion interacts with the key door 302.

However, if the position at which the coupling member 700 is to be engaged with the latch housing 501 is biased to the left or right, the opposite side of the side to be engaged moves away from the front panel 120. In this case, since the detecting portion on the center side also moves away from the front panel 120, the positional relationship between the detecting portion and the key door 302 changes. Therefore, in this case, the position at which the detecting portion and the key door 302 interact may be affected.

As described above, if the latch housing 501 is coupled to the back side of the front panel 120 at the opening connecting portion 120c, together with the coupling member 700 being coupled at a position where the coupling member 700 is obscured by the manipulation portion 800, the position where the latch housing 501 and the coupling member 700 are coupled becomes one side of the latch housing 501. If the side of the latch housing 501 facing the front panel 120 is flat, in this case, the position relationship of the detection part and the key door 302 may be distorted, and accurate detection of the opening and closing of the door 300 may become difficult.

As shown in FIG. 22, if the side of the latch housing 501 facing the front panel 120 is concave to form a latch recess 504 in a direction opposite to the direction facing the front panel 120, the concave side will engage the coupling member 700. When the latch housing 501 is engaged with the front panel 120 by the coupling member 700 on the concave side, the left and right ends of the concave side are pulled toward the front panel 120 by the force of engagement. In this case, the position relationship of the detecting part and the key door 302 does not change, so it is possible to accurately detect the opening and closing of the door 300.

The latch recess 504 may be shaped as a curved surface, but may also include a combination of planes for ease of manufacturing. The latch recess 504 may be a combination of two planes. Referring to the two planes as a first latch plane 504a and a second latch plane 504b, respectively, the latch recess 504 may further include a latch plane connecting portion 504c where the first latch plane 504a and the second latch plane 504b meet.

Since the latch housing 501 is coupled adjacent to the front panel 120, the latch plane connecting portion 504c may have a shape corresponding to the shape of the front panel 120. If the front panel 120 of the corresponding portion of the latch plane connecting portion 504c has a stepped shape, the shape of the latch plane connecting portion 504c may also be a stepped shape. By making the shapes of the front panel 120 and the latch plane connecting portion 504c correspond, it is possible to more closely couple the front panel 120 and the latch housing 501.

As shown in FIGS. 21 and 22, the first plane along the B direction may be a plane corresponding to a location of the key door opening 503. The second plane along the B direction can be a plane corresponding to the coupling opening 502. That is, the coupling opening 502 can be positioned within a recess of the latch recess 504 so that when the latch housing 501 is coupled to the front panel 120 by the coupling member 700, a force directed toward the front panel 120 can be generated within the recess of the latch recess 504. At this time, the key door opening 503 may be positioned within or aligned with the concave side of the latch recess 504 to accurately position the key door opening 503.

The portion where the latch housing 501 touches the front panel 120 by the latch recess 504 may be referred to as the latch end portion 504d. To summarize, the latch recess 504 may include or be defined by a first latch plane 504a, a second latch plane 504b, a latch plane connecting portion 504c, and a latch end portion 504d. In an embodiment, for example, the surface of the latch housing 501 which defines the latch recess 504 includes a first surface in a first plane (e.g., along dotted line ‘A’ in FIG. 22), and a second surface in a second plane (e.g., along dotted line ‘B’ in FIG. 22) which forms an angle with the first plane. That is, a step is defined between the first surface and the second surface of the latch housing 501, and the step of the latch housing 501 corresponds to a shape of the front panel 120 to more closely couple the front panel 120 and the latch housing 501 to each other.

At a side of the latch housing 501 closest to the front panel 120 a latch protruding portion 505 protrudes toward the front panel 120. A plurality of planes may be made by connecting the ends of the latch protruding portion 505 which are closest to the front panel 120, where the plurality of planes may include a first latch plane 504a and a second latch plane 504b together forming the latch recess 504. Since the-described effect is produced by the shape of the part of the latch housing 501 that contacts the front panel 120, when forming the latch protruding portion 505, it is possible to have the-described effect if the plane formed by the ends of the latch protruding portion 505 has the features. In this case, it is not necessary to form the first latch plane 504a and the second latch plane 504b on all of the sides facing the front panel 120 of the latch housing 501, so less material can be used to manufacture the latch housing 501. Therefore, in this case, the cost of manufacturing the latch housing 501 may be reduced.

Since the first latch plane 504a may be formed corresponding to a position of the key door opening 503 and the second latch plane 504b may be formed corresponding to a position of the coupling opening 502, the latch protruding portion 505 may also be formed around the key door opening 503 and the coupling opening 502, respectively, in the plan view (e.g., an A-C plane). The latch protruding portion 505 formed around the key door opening 503 may be referred to as the first latch protruding portion 505a, and the latch protruding portion 505 formed around the coupling opening 502 may be referred to as the second latch protruding portion 505b.

In other words, the first latch plane 504a and the second latch plane 504b can form a latch recess 504 that is recessed in the opposite direction of the direction in which the latch 500 faces the front panel 120.

The latch recess 504 may include a first latch plane 504a together with a second latch plane 504b, a latch plane connecting portion 504c that connects the first latch plane 504a and the second latch plane 504b to each other, and a latch end portion 504d that is the portion where the latch housing 501 abuts (and contacts) the front panel 120.

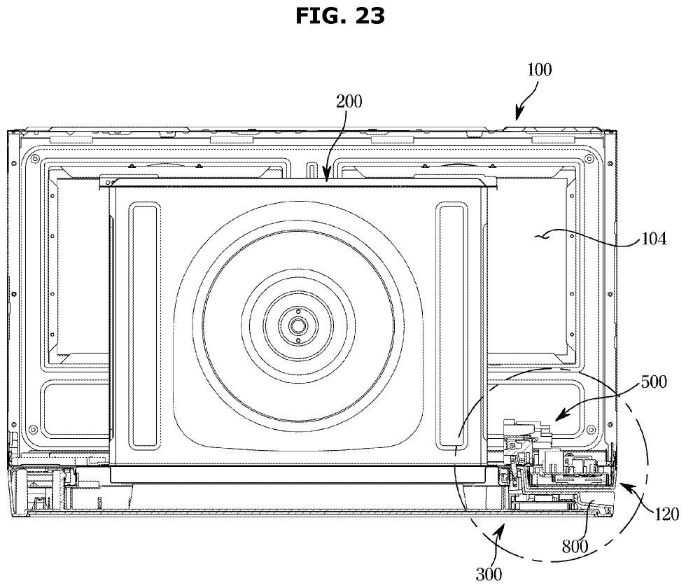

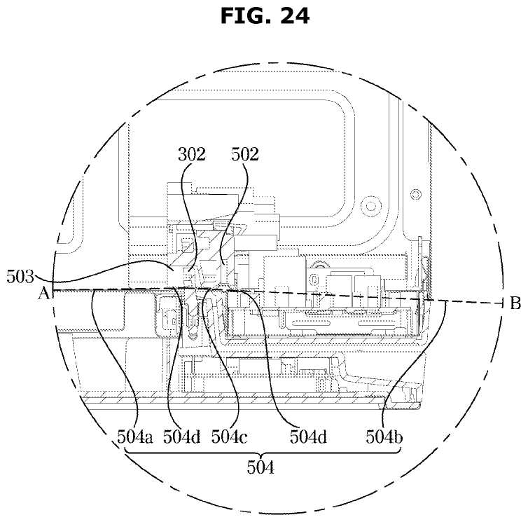

FIG. 23 is a cross-sectional view of the cooking apparatus 1 of FIG. 15, shown from above. FIG. 24 is an enlarged cross-sectional view of the indicated portion of FIG. 23.

As shown in FIGS. 23 and 24, the latch 500 may engage the front panel 120 at a location corresponding to the front panel 120 that is obscured by the manipulation portion 800.

When the latch housing 501 is engaged with the front panel 120, the latch housing 501 may include a latch recess 504 so that only the latch end portion 504d is in contact with the front panel 120. This allows the latch 500 to engage in a precise location, and the key door 302 to be inserted into the latch housing 501 precisely so that the interaction of the key door 302 with the detecting portion can occur accurately. Thus, the opening and closing of the door 300 can be accurately detected.

Specific embodiments have been shown and described above. However, the invention is not limited to the embodiments, and one having ordinary skill in the art to which the invention belongs will be able to make various modifications without departing from the spirit of the technical idea of the invention set forth in the following claims.

In an embodiment, a cooking apparatus 1 includes a coupling member 700 which couples the latch to the front panel 120 of the outer housing 100, and a manipulation portion 800 through which an input is provided to the cooking apparatus 1 from outside thereof, the manipulation portion 800 coupled to the front panel 120 at a front side of the front panel 120 which is opposite to the back surface. The manipulation portion 800 coupled to the front panel 120 covers the coupling member 700 which couples the latch 500 to the front panel 120. The cooking apparatus 1 having the door 300 which is open includes the manipulation portion 800 visible from outside of the cooking apparatus 1, together with the coupling member 700 which is covered by the manipulation portion 800 being invisible from the outside of the cooking apparatus 1.

In an embodiment, the latch 500 includes a latch housing 501 which forms an exterior of the latch 500. The latch housing 501 includes a surface which faces the back surface of the front panel 120 of the outer housing and defines a latch recess 504 which is concave in a direction away from the front panel 120, and the surface includes end portions 504d at opposing sides of the latch recess 504, both of the end portions in contact with the back surface of the front panel 120. A detector (e.g., 530, 540 and/or 540′) which is coupled to the latch housing 501 at an interior of the latch housing 501 detects the opening and closing of the door 300.

In an embodiment, the surface of the latch housing 501 which defines the latch recess 504 includes a first surface in a first plane, and a second surface in a second plane which forms an angle with the first plane. A coupling member 700 couples the latch 500 to the front panel 120 of the outer housing 100, at a portion of the latch housing 501 which is spaced apart from the back surface of the front panel 120. Each of the first surface and the second surface of the latch housing 501 is spaced apart from the back surface of the front panel 120, and a distance by which the portion of the latch housing 501 is spaced apart from the back surface of the front panel 120 is greater than respective distances by which the first surface and the second surface are spaced apart from the back surface of the front panel 120. The surface of the latch housing 501 which faces the back surface of the front panel 120 includes a latch protruding portion projecting toward the front panel, and the latch protruding portion defines the first surface and the second surface.

In an embodiment, the back panel is opposite to the front panel 120 of the outer housing 100, in a direction, the door includes a door key (e.g., key door 302) which protrudes in the direction and is engageable with the latch 500 in detection of the opening and closing of the door 300 by the latch 500. The latch housing 501 defines a door key opening of the latch housing through which the door key of the door is received, and a coupling member opening of the latch housing in which the coupling member is received The latch protruding portion extends around the door key opening or the coupling member opening. Within the latch housing, the door key opening is defined in the first surface, and the coupling member opening is defined in the second surface.

In an embodiment, the front panel of the outer housing includes a side of the opening connection portion which is bent to define a latch guide, and a latch protrusion accommodating hole defined in the latch guide. The latch housing includes a latch protrusion which is received in the latch protrusion accommodating hole of the opening connecting portion.

In an embodiment, a cover member is coupled to the outer housing and faces a front surface of the front panel which is opposite to the back surface of the front panel. The door includes a side, and the cooking apparatus having the door which is closed includes the cover member surrounding the side of the door.

In an embodiment, the coupling member penetrates the latch and the front panel of the outer housing in the coupling of the latch to the front panel, and the coupling member which extends into the fastening groove of the cover member is covered by the cover member to be invisible from the outside of the cooking apparatus.

In an embodiment, the cover member defines a cover member opening, and the cooking apparatus having the door which is closed includes a portion of the side of the door accommodated in the cover member opening.

In an embodiment, the detector of the latch includes a detector button, the door includes a door key which is engageable with the latch in detection of the opening and closing of the door by the latch, and the closing of the door includes the door key of the door engaged with the latch together with the detector button actuated by engagement of the door key with the latch.

In an embodiment, the detector of the latch is provided in plural including a plurality of detectors actuated in the closing of the door, the door includes a door key which is directly engageable with one detector among the plurality of detectors in the detecting of the opening and closing of the door by the latch, and the closing of the door includes the door key of the door directly engaged with the one detector of the latch together with the each of the plurality of detectors being actuated.

In an embodiment, a cooking apparatus includes a housing in which a cooking space is defined, the housing including a front panel at which the cooking space is open to outside the housing, a door which faces a front surface of the front panel, the door being openable and closeable to respectively expose and close the cooking space relative to the outside of the housing, and a detector which detects opening and closing of the door and faces a back surface of the front panel which is opposite to the front surface of the front panel. The door which is closed includes the door extending through the front panel, in a direction from the front surface to the back surface of the panel, together with the door directly engaging with the detector. Here, a surface of the detector which faces the back surface of the front panel is concave in a direction away from the front panel to define a recess of the detector, along the surface of the detector, the recess is defined by a first surface in a first plane, and a second surface which is in a second plane which forms an angle with the first plane, the second plane being closer to the front panel than the first surface, and the door which is closed includes the door extending through the front panel at a location corresponding to the second surface.

What is claimed is:

1. A cooking apparatus comprising:
an outer housing including a front panel and a back panel opposite to each other, the front panel including a back surface facing the back panel;
an inner housing which is within the outer housing and in which a cooking room of the cooking apparatus is defined;
a door which is rotatably coupled to the outer housing at the front panel of the outer housing, and opens and closes the cooking room; and
a latch which is coupled to the outer housing at the back surface of the front panel and detects opening and closing of the door.

2. The cooking apparatus of claim 1, further comprising:
a coupling member which couples the latch to the front panel of the outer housing, and
a manipulation portion through which an input is provided to the cooking apparatus from outside thereof, the manipulation portion coupled to the front panel at a front side of the front panel, which is opposite to the back surface,
wherein
the manipulation portion coupled to the front panel covers the coupling member which couples the latch to the front panel, and
the cooking apparatus having the door which is open includes the manipulation portion visible from outside of the cooking apparatus, together with the coupling member which is covered by the manipulation portion being invisible from the outside of the cooking apparatus.

3. The cooking apparatus of claim 1, wherein the latch includes:
a latch housing which forms an exterior of the latch, the latch housing comprising:
a surface which faces the back surface of the front panel of the outer housing and defines a latch recess which is concave in a direction away from the front panel, and
the surface including end portions at opposing sides of the latch recess, both of the end portions in contact with the back surface of the front panel; and
a detector which is coupled to the latch housing at an interior of the latch housing and detects the opening and closing of the door.

4. The cooking apparatus of claim 3, wherein the surface of the latch housing which defines the latch recess includes:
a first surface in a first plane, and
a second surface in a second plane which forms an angle with the first plane.

5. The cooking apparatus of claim 4, further comprising a coupling member which couples the latch to the front panel of the outer housing, at a portion of the latch housing which is spaced apart from the back surface of the front panel,
wherein
each of the first surface and the second surface of the latch housing is spaced apart from the back surface of the front panel, and
a distance by which the portion of the latch housing is spaced apart from the back surface of the front panel is greater than respective distances by which the first surface and the second surface are spaced apart from the back surface of the front panel.

6. The cooking apparatus of claim 4, wherein
a step is defined between the first surface and the second surface of the latch housing, and
the step of the latch housing corresponds to a shape of the front panel of the outer housing.

7. The cooking apparatus of claim 4, wherein
the surface of the latch housing which faces the back surface of the front panel includes a latch protruding portion projecting toward the front panel,
the latch protruding portion defines the first surface and the second surface.

8. The cooking apparatus of claim 7, further comprising a coupling member which couples the latch to the front panel of the outer housing,
wherein
the back panel is opposite to the front panel of the outer housing, in a direction,
the door comprises a door key which protrudes in the direction and is engageable with the latch in detection of the opening and closing of the door by the latch,
the latch housing defines:
a door key opening of the latch housing through which the door key of the door is received; and
a coupling member opening of the latch housing in which the coupling member is received, and
the latch protruding portion extends around the door key opening or the coupling member opening.

9. The cooking apparatus of claim 8, wherein within the latch housing:
the door key opening is defined in the first surface, and
the coupling member opening is defined in the second surface.

10. The cooking apparatus of claim 2, wherein
the front panel of the outer housing defines:
a cooking room opening corresponding to the cooking room;
a manipulation portion opening corresponding to the manipulation portion; and
an opening connecting portion between the cooking room opening and the manipulation portion opening, and
the latch is coupled to the front panel at the opening connecting portion.

11. The cooking apparatus of claim 10, wherein
the front panel of the outer housing includes:
a side of the opening connecting portion, which is bent to define a latch guide, and
a latch protrusion accommodating hole defined in the latch guide, and
the latch includes:
a latch housing which forms an exterior of the latch, and
the latch housing including a latch protrusion which is received in the latch protrusion accommodating hole of the opening connecting portion.

12. The cooking apparatus of claim 1, further comprising a cover member which is coupled to the outer housing and faces a front surface of the front panel which is opposite to the back surface of the front panel,
wherein
the door includes a side, and
the cooking apparatus having the door which is closed includes the cover member surrounding the side of the door.

13. The cooking apparatus of claim 12, further comprising a coupling member which couples the latch to the front panel of the outer housing,
wherein the cover member which faces the front surface of the front panel defines a fastening groove into which the coupling member extends in coupling of the latch to the front panel.

14. The cooking apparatus of claim 13, wherein
the coupling member penetrates the latch and the front panel of the outer housing in the coupling of the latch to the front panel, and
the coupling member which extends into the fastening groove of the cover member is covered by the cover member to be invisible from the outside of the cooking apparatus.

15. The cooking apparatus of claim 12, wherein
the cover member defines a cover member opening, and
the cooking apparatus having the door which is closed includes a portion of the side of the door accommodated in the cover member opening.

16. The cooking apparatus of claim 3, wherein
the detector of the latch includes a detector button,
the door comprises a door key which is engageable with the latch in detection of the opening and closing of the door by the latch, and
the closing of the door includes the door key of the door engaged with the latch together with the detector button actuated by engagement of the door key with the latch.

17. The cooking apparatus of claim 3, wherein
the detector of the latch is provided in plural including a plurality of detectors actuated in the closing of the door,
the door comprises a door key which is directly engageable with one detector among the plurality of detectors in the detecting of the opening and closing of the door by the latch, and
the closing of the door includes the door key of the door directly engaged with the one detector of the latch together with the each of the plurality of detectors being actuated.

18. The cooking apparatus of claim 9, wherein the first surface in which the door key opening is defined is closer to the back surface of the front panel than the second surface in which the coupling member opening is defined.

19. A cooking apparatus comprising:
a housing in which a cooking space is defined, the housing including a front panel at which the cooking space is open to outside the housing;
a door which faces a front surface of the front panel, the door being openable and closeable to respectively expose and close the cooking space relative to the outside of the housing; and
a detector which detects opening and closing of the door and faces a back surface of the front panel which is opposite to the front surface of the front panel,
wherein the door which is closed includes the door extending through the front panel, in a direction from the front surface to the back surface of the front panel, together with the door directly engaging with the detector.

20. The cooking apparatus of claim 19, wherein
a surface of the detector which faces the back surface of the front panel is concave in a direction away from the front panel to define a recess of the detector,
along the surface of the detector, the recess is defined by a first surface in a first plane, and a second surface which is in a second plane which forms an angle with the first plane, the second plane being closer to the front panel than the first surface, and
the door which is closed includes the door extending through the front panel at a location corresponding to the second surface.
